(19) United States
(12) Patent Application Publication
(10) Pub. No.: US 2012/0207267 A1
(43) Pub. Date: Aug. 16, 2012

(54) ARRANGEMENT FOR CONTACTLESS TRANSMISSION OF ELECTRIC SIGNALS IN A COMPUTED TOMOGRAPHY SYSTEM

(76) Inventors: Horst Friesner, Altendorf (DE); Florian Hofmann, Erlangen (DE); Thomas Luthardt, Bamberg (DE); Helmut Repp, Erlangen (DE)

(21) Appl. No.: 13/208,219

(22) Filed: Aug. 11, 2011

(30) Foreign Application Priority Data
Aug. 12, 2010 (DE) 10 2010 034 100.2

(51) Int. Cl. H05G 1/60; H01Q 21/28

(52) U.S. Cl. 378/4; 343/893

(57) ABSTRACT

An arrangement includes at least one annular conductor arranged on a rotatable gantry part. The at least one annular conductor is operable to emit electric signals. The conductor is divided into n, where nεN and n>1, rotationally symmetrically arranged annular conductor segments that have no electric connection to one another, and n transmit units. The transmit units are each arranged on different annular conductor segments and each feed different electric signals into the annular conductor segments. Angles between the transmit units and one end of corresponding annular conductor segments are of equal size.

This application claims the benefit of DE 10 2010 034 100.2, filed on Aug. 12, 2010.

### BACKGROUND

The present embodiments relate to an arrangement for contactless transmission of electric signals between a fixed gantry part of a computed tomography system and a gantry part that may be rotated about an axis of rotation.

When the computed tomography system is in operation, data captured by x-ray detectors is to be transmitted from the rotating part to the stationary part of the computed tomography system in order to be further processed at the stationary part. The ongoing further development of computed tomography systems provides that the amount of data to be transmitted per time unit is constantly increasing.

Computed tomography systems may use a “slip ring” system for data transmission (e.g., as is known from U.S. Pat. No. 5,140,696 A). The data transmission system includes a transmit unit on the rotating part and a receive unit on the stationary part. The transmit unit has at least one high-frequency line connected to a transmitter as a transmit antenna. The transmit antenna is arranged on the circumference of the rotating part of the rotating frame. The receive unit includes a receiver and at least one receive antenna connected to the receiver. The at least one receive antenna is formed by a short section of a high-frequency line. When the computed tomography system is in operation, the transmit antenna moves in close proximity past the receive antenna attached to the stationary part so that signals propagating on the transmitting high-frequency line couple capacitively into the receive antenna via an evanescent wave that forms. The transmit unit is arranged at the high-frequency line in the rotatable part, where a corresponding installation space is available.

### SUMMARY AND DESCRIPTION

The present embodiments may obviate one or more of the drawbacks or limitations in the related art. For example, an arrangement for contactless transmission of electric signals between two gantry parts of a computed tomography system that rotate relative to one another is provided.

In one embodiment, an arrangement for contactless transmission of electric signals between a fixed gantry part of a computed tomography system and a gantry part that may be rotated about an axis of rotation is provided. The arrangement includes at least one annular conductor arranged on the rotatable gantry part. The at least one annular conductor is operable to emit the electric signals, where the conductor is divided into n (where nεN and n>1) rotationally symmetrically arranged annular conductor segments (e.g., a plurality of annular conductor segments) that have no electric connection to one another. The conductor also includes n transmit units that are each arranged on different annular conductor segments. Each of the transmit units feeds different electric signals into the annular conductor segments. Angles between the transmit units and an end of corresponding annular conductor segments of the plurality are of equal size. The present embodiments offer the advantage that available installation spaces may be taken into account more simply, and identical circular conductor segments may be used with corresponding transmit units.

In one embodiment, the axis of rotation may be a system axis of the computed tomography system.

In another embodiment, a circle center of the annular conductor may lie on the axis of rotation of the rotatable gantry part.

In one embodiment, n may be <5. As a result, the number of circular conductor segments is limited.

The transmit units may not be arranged centrally on the annular conductor segment (e.g., the angle is less than 180/n).

In one embodiment, n=2 is possible, and both transmit units may be arranged symmetrically to a diameter of the annular conductor.

In another embodiment, n=3 is possible, and two of the three transmit units may be arranged symmetrically to a diameter of the annular conductor.

Additionally, n=4 is possible, and in each case, two of the four transmit units may be arranged symmetrically to a diameter of the annular conductor.

A computed tomography system with a gantry that includes two gantry parts and one embodiment of an arrangement may be provided.

### BRIEF DESCRIPTION OF THE DRAWINGS

FIG. 1 shows one embodiment of a computed tomography system;

FIG. 2 shows one embodiment of an arrangement of two annular conductor segments for contactless transmission of electric signals;

FIG. 3 shows one embodiment of an arrangement of three annular conductor segments for contactless transmission of electric signals; and

FIG. 4 shows one embodiment of an arrangement of four annular conductor segments for contactless transmission of electric signals

### DETAILED DESCRIPTION OF THE DRAWINGS

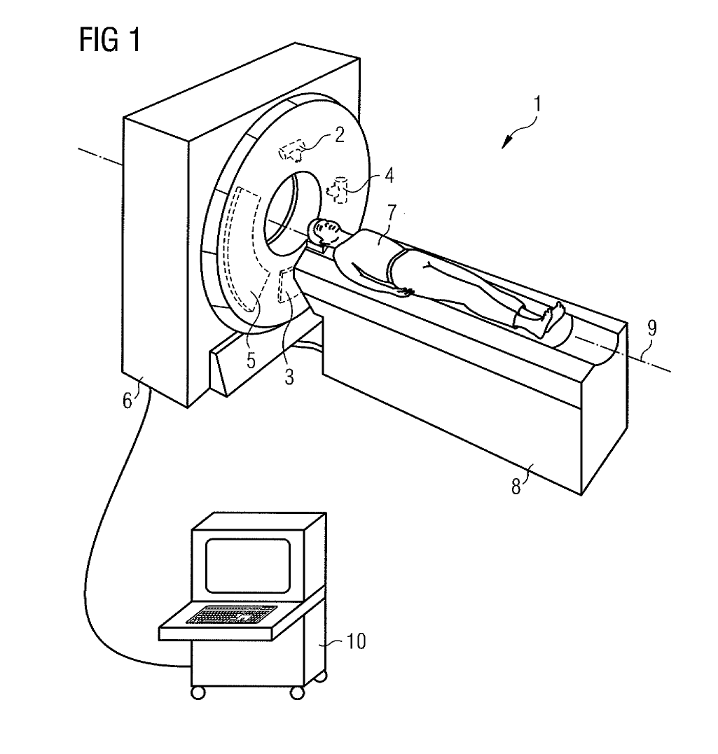

FIG. 1 shows one embodiment of a computed tomography system 1 with a fixed gantry part 6, in which a rotatable gantry part 11 is located. A first tube/detector system including an x-ray tube 2 and a detector 3 is arranged on the rotatable gantry part 11. Alternatively, one or more additional tube/detector systems may be affixed, as is shown in FIG. 1 with an x-ray tube 4 and an opposing detector 5. For an examination, a patient 7 is introduced into a measurement field with the aid of a patient couch 8 that may be moved along a system axis 9 so that an absorption of x-ray radiation may be measured from different projection angles. To control the system 1, a computer 10 designed as a control and arithmetic unit is used. Computer programs that execute control of the system 1, an evaluation of measured data, and a reconstruction of the desired tomographic image data run on the computer 10.

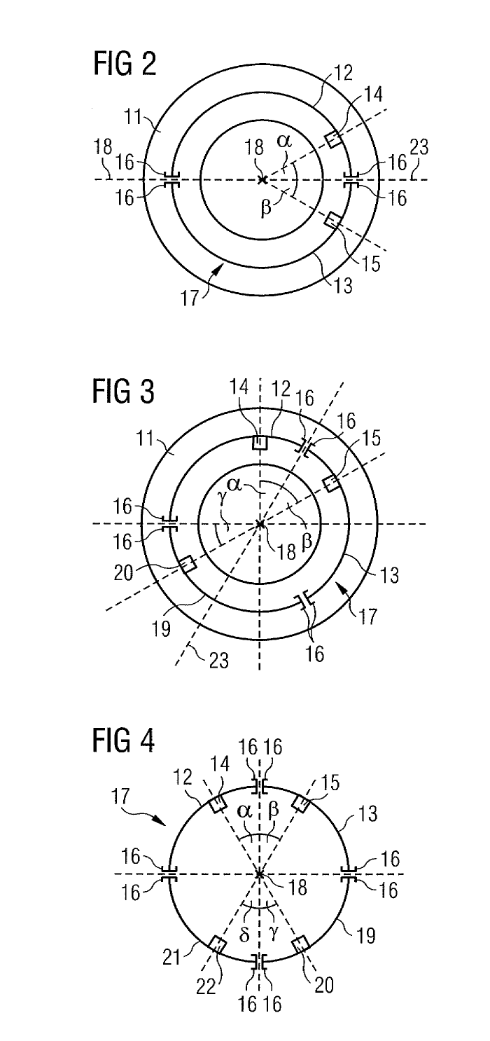

For example, during transmission of the detector data from the at least one detector 3 on the rotatable gantry part 11, a large mass of incoming data is transmitted via a contactless path. One embodiment of an arrangement for contactless transmission of electric signals is affixed to the rotatable gantry part 11, so the electric signals may be transmitted between the fixed gantry part 6 and the rotatable gantry part 11 that may be rotated relative to one another. Exemplary embodiments of the arrangement are described in greater detail in FIGS. 2 to 4.

FIG. 2 shows one embodiment of an arrangement of an annular conductor 17 on the rotatable gantry part 11 for contactless transmission of electric signals from the rotatable gantry part 11 to the fixed gantry part (not shown). The annular conductor 17 acts as an antenna and emits electromagnetic radiation that may be recorded by a receive antenna (not shown) arranged on the fixed gantry part. The conductor 17 rotates together with the rotatable gantry part 11 in operation about an axis of rotation 18.

The conductor 17 is divided into two equal-sized circular conductor segments 12, 13. The circular conductor segments are each provided with conductor terminations 16 at both ends to prevent reflections on the circular conductor segments 12, 13. Transmit signals are fed into the circular conductor segments 12, 13 via transmit units 14, 15. Since the transmit units 14, 15 feed different signals in, the transmit units 14, 15 may essentially be arranged at any position on the circular conductor segment 12, 13. Because of the permissible transit time differences to the conductor terminations 16, the transmit units 14, may not be arranged centrally on the circular conductor segments 12, 13.

In one embodiment, essentially identical circular conductor segments 12, 13, in which the transmit units 14, 15 are each arranged offset from a conductor termination 16 by the same angles α, β, are used To achieve the arrangement according to FIG. 2, the circular conductor segment 13 is, for example, installed rotated about an axis of the circular conductor segment 13 by 180°. The transmit units 14 and 15 lie symmetrically to a diameter 23 of the conductor 17. Due to the arbitrary arrangement of the transmit unit 14 along the circular conductor segment 12, there is a greater probability of finding a suitable free space for installation in the rotatable gantry part 11. By using identical circular conductor segments 12, 13 with the correspondingly arranged transmit units 14, 15, manufacture is simplified and becomes more economical.

FIG. 3 shows one embodiment of an arrangement of an annular conductor 17 on the rotatable gantry part 11 for contactless transmission of electric signals from the rotatable gantry part 11 to the fixed gantry part (not shown). The conductor 17 acts as an antenna and emits electromagnetic radiation that may be recorded by a receive antenna (not shown) arranged on the fixed gantry part. The conductor 17 rotates together with the rotatable gantry part 11 in operation about an axis of rotation 18.

The conductor 17 is divided into three equal-sized circular conductor segments 12, 13, 19. The circular conductor segments 12, 13, 19 are each provided with conductor terminations 16 at both ends to prevent reflections on the circular conductor segments 12, 13, 19. Transmit signals are fed into the circular conductor segments 12, 13, 19 via transmit units 14, 15, 20. Since the transmit units 14, 15, 20 feed different signals in, the transmit units 14, 15, 20 may essentially be arranged at any position on the circular conductor segment 12, 13, 20. Because of the permissible transit time differences to the conductor terminations 16, the transmit units 14, 15, 20 may not be arranged centrally on the circular conductor segments 12, 13, 19.

In one embodiment, essentially identical circular conductor segments 12, 13, 20, in which the transmit units 14, 15, 20 are each arranged offset from a conductor termination 16 by the same angles α, β, γ, are used. To achieve the arrangement according to FIG. 3, the circular conductor segment 15 is, for example, installed rotated about an axis of the circular conductor segment 15 by 180°. As a result, the transmit units 14 and 15 lie symmetrically to a diameter 23 of the conductor 17. Due to the arbitrary arrangement of the transmit unit 14 along the circular conductor segment 12, a suitable free space may be found for installation in the rotatable gantry part 11. By using identical circular conductor segments 12, 13, 19 with the correspondingly arranged transmit units 14, 15, 20, manufacture is simplified and becomes more economical.

FIG. 4 shows one embodiment of an arrangement of an annular conductor 17 for the rotatable gantry part (not shown) for contactless transmission of electric signals from the rotatable gantry part to the fixed gantry part (not shown). The conductor 17 acts as an antenna and emits electromagnetic radiation that may be recorded by a receive antenna (not shown) arranged on the fixed gantry part. The conductor 17 rotates together with the rotatable gantry part in operation about an axis of rotation 18.

The conductor 17 is divided into four equal-sized circular conductor segments 12, 13, 19, 21. The circular conductor segments 12, 13, 19, 21 are each provided with conductor terminations 16 at both ends to prevent reflections on the circular conductor segments 12, 13, 19, 21. Transmit signals are fed into the circular conductor segments 12, 13, 19, 21 via transmit units 14, 15, 20, 22. Since the transmit units 14, 15, 20, 22 feed different signals in, the transmit units 14, 15, 20, 22 may essentially be arranged at any position on the circular conductor segment 12, 13, 19, 21. Because of the permissible transit time differences to the conductor terminations 16, the transmit units 14, 15, 20, 22 may not be arranged centrally on the circular conductor segments 12, 13, 19, 21.

In one embodiment, essentially identical circular conductor segments 12, 13, 20, 22, in which the transmit units 14, 15, 20 are each arranged offset from a conductor termination 16 by the same angles α, β, γ, δ, are used. To achieve the arrangement according to FIG. 4, the circular conductor segments 13 and 21 are each, for example, installed rotated about an axis of the circular conductor segment 13 or 21 by 180°. As a result, the transmit units 14 and 15, 20 and 22 each lie symmetrically to a diameter 23 of the conductor 17. Due to the arbitrary arrangement of the transmit unit 14 along the circular conductor segment 12, there is a greater probability of finding a suitable free space for installation in the rotatable gantry part. By using identical circular conductor segments 12, 13, 19, 21 with the correspondingly arranged transmit units 14, 15, 20, 22, manufacture is simplified and becomes more economical.

In a further embodiment, the arrangement may alternatively be arranged on the fixed gantry part 6 in FIG. 1.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. An arrangement for contactless transmission of electric signals between a fixed gantry part of a computed tomography system and a gantry part rotatable about an axis of rotation, the arrangement comprising:
an annular conductor arranged on the rotatable gantry part, the annular conductor operable to emit the electric signals, wherein the annular conductor is divided into a plurality of rotationally symmetrically arranged annular conductor segments that have no electric connection to one another; and
transmit units that are each arranged on different annular conductor segments of the plurality and that each feed different electric signals into the plurality of rotationally symmetrically arranged annular conductor segments, wherein angles between each of the transmit units and one end of a corresponding annular conductor segment of the plurality are of equal size.

2. The arrangement as claimed in claim 1, wherein the axis of rotation is a system axis of the computed tomography system.

3. The arrangement as claimed in claim 2, wherein a circle center of the annular conductor lies on the axis of rotation of the rotatable gantry part.

4. The arrangement as claimed in claim 1, wherein the plurality of rotationally symmetrically arranged annular conductor segments comprises less than five rotationally symmetrically arranged annular conductor segments.

5. The arrangement as claimed in claim 1, wherein the angles are less than 180° divided by the number of rotationally symmetrically arranged annular conductor segments.

6. The arrangement as claimed in claim 1, wherein the plurality of rotationally symmetrically arranged annular conductor segments comprises two rotationally symmetrically arranged annular conductor segments, and
wherein the transmit units are arranged symmetrically to a diameter of the annular conductor.

7. The arrangement as claimed in claim 1, wherein the plurality of rotationally symmetrically arranged annular conductor segments comprises three rotationally symmetrically arranged annular conductor segments, and
wherein two of the transmit units are arranged symmetrically to a diameter of the annular conductor.

8. The arrangement as claimed in claim 1, wherein the plurality of rotationally symmetrically arranged annular conductor segments comprises four rotationally symmetrically arranged annular conductor segments, and
wherein two of the transmit units are arranged symmetrically to a diameter of the annular conductor.

9. The arrangement as claimed in claim 2, wherein the plurality of rotationally symmetrically arranged annular conductor segments comprises less than five rotationally symmetrically arranged annular conductor segments.

10. The arrangement as claimed in claim 2, wherein the angles are less than 180° divided by the number of rotationally symmetrically arranged annular conductor segments.

11. The arrangement as claimed in claim 2, wherein the plurality of rotationally symmetrically arranged annular conductor segments comprises two rotationally symmetrically arranged annular conductor segments, and
wherein the transmit units are arranged symmetrically to a diameter of the annular conductor.

12. The arrangement as claimed in claim 2, wherein the plurality of rotationally symmetrically arranged annular conductor segments comprises three rotationally symmetrically arranged annular conductor segments, and
wherein two of the transmit units are arranged symmetrically to a diameter of the annular conductor.

13. The arrangement as claimed in claim 2, wherein the plurality of rotationally symmetrically arranged annular conductor segments comprises four rotationally symmetrically arranged annular conductor segments, and
wherein two of the transmit units are arranged symmetrically to a diameter of the annular conductor.

14. The arrangement as claimed in claim 3, wherein the plurality of rotationally symmetrically arranged annular conductor segments comprises less than five rotationally symmetrically arranged annular conductor segments.

15. The arrangement as claimed in claim 3, wherein the angles are less than 180° divided by the number of rotationally symmetrically arranged annular conductor segments.

16. The arrangement as claimed in claim 3, wherein the plurality of rotationally symmetrically arranged annular conductor segments comprises two rotationally symmetrically arranged annular conductor segments, and
wherein the transmit units are arranged symmetrically to a diameter of the annular conductor.

17. The arrangement as claimed in claim 3, wherein the plurality of rotationally symmetrically arranged annular conductor segments comprises three rotationally symmetrically arranged annular conductor segments, and
wherein two of the transmit units are arranged symmetrically to a diameter of the annular conductor.

18. The arrangement as claimed in claim 3, wherein the plurality of rotationally symmetrically arranged annular conductor segments comprises four rotationally symmetrically arranged annular conductor segments, and
wherein two of the transmit units are arranged symmetrically to a diameter of the annular conductor.

19. A computed tomography system comprising:
a gantry comprising a fixed gantry part and a gantry part rotatable about an axis of rotation; and
an arrangement for contactless transmission of electric signals between the fixed gantry part and the rotatable gantry part, the arrangement comprising:
an annular conductor, the annular conductor operable to emit the electric signals, wherein the annular conductor is divided into a plurality of rotationally symmetrically arranged annular conductor segments that have no electric connection to one another; and
transmit units that are each arranged on different annular conductor segments of the plurality and that each feed different electric signals into the plurality of rotationally symmetrically arranged annular conductor segments, wherein angles between each of the transmit units and one end of a corresponding annular conductor segment of the plurality are of equal size.
